(19) United States
(12) Patent Application Publication
(10) Pub. No.: US 2025/0266733 A1
(43) Pub. Date: Aug. 21, 2025

(54) SEALING DEVICE AND AN IN-WHEEL MOTOR INCLUDING THE SAME

(71) Applicants: HYUNDAI MOTOR COMPANY, Seoul (KR); KIA CORPORATION, Seoul (KR)

(72) Inventors: Ki Tack Lim, Incheon (KR); Jeong Uk An, Suwon-si (KR); Chee Mann Kim, Seoul (KR); Kam Chun Lee, Seoul (KR); Hong Wook Lee, Seongnam-si (KR); Kyung Ku Yeo, Yongin-si (KR)

(73) Assignees: HYUNDAI MOTOR COMPANY, Seoul (KR); KIA CORPORATION, Seoul (KR)

(21) Appl. No.: 18/795,895

(22) Filed: Aug. 6, 2024

(30) Foreign Application Priority Data
Feb. 16, 2024 (KR) 10-2024-0022554

(51) Int. Cl. H02K 5/10; B60K 7/00; F16J 15/3204; H02K 21/22

(52) U.S. Cl. CPC H02K 5/10; B60K 7/0007; F16J 15/3204; H02K 21/22; B60K 2007/0092

(57) ABSTRACT

An in-wheel motor includes a stator, a rotor rotatably disposed relative to the stator, and a seal connected to the stator and disposed to be in contact with a part of the rotor. In particular, the part of the rotor includes a coated surface, and the seal may be made of a low friction material and a low wear material.

### CROSS-REFERENCE TO RELATED APPLICATION

This application claims, under 35 U.S.C. § 119 (a), the benefit of priority from Korean Patent Application No. 10-2024-0022554, filed on Feb. 16, 2024, the entire contents of which are incorporated herein by reference.

### TECHNICAL FIELD

The present disclosure relates to a sealing device and an in-wheel motor including the same.

### BACKGROUND

Electric vehicles driven by motors instead of engines have received considerable attention in recent years. Generally, electric vehicles are configured to be driven by one or two large motors. Meanwhile, in-wheel motors are widely used in small vehicles, such as electric bicycles and scooters. Recently, the in-wheel motors are being applied to electric cars.

An in-wheel motor is an electric motor mounted in a wheel of a vehicle and configured to directly rotate the wheel. Specifically, in an electric vehicle driven by the in-wheel motor, a small motor is mounted in each wheel so as to independently drive and control each wheel.

The electric vehicle having the in-wheel motor mounted therein may provide various advantages, such as excellent space utilization and improved control performance, compared to an electric vehicle having an existing large motor mounted therein. However, since the electric vehicle driven by the in-wheel motor has a motor provided in each wheel, it is necessary to meet several design conditions different from design conditions of an electric vehicle driven by one large motor.

The above information disclosed in this Background section is provided only to enhance understanding of the background of the disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and it is an object of the present disclosure to provide a sealing device capable of providing excellent sealing force between a rotating body and a fixed body.

Particularly, the present disclosure provides a sealing device for an in-wheel motor in consideration of characteristics of the in-wheel motor, and also provides an in-wheel motor including the sealing device.

Further, the present disclosure provides a low friction and/or low wear sealing device and an in-wheel motor including the sealing device.

Additionally, the present disclosure provides a sealing device having improved durability and an in-wheel motor including the sealing device.

Moreover, the present disclosure provides a sealing device capable of improving efficiency of a motor and fuel efficiency of an electric vehicle, and an in-wheel motor including the sealing device.

The objects of the present disclosure are not limited to the above-mentioned objects, and other technical objects not mentioned herein should be clearly understood by those having ordinary skill in the art to which the present disclosure pertains (referred to hereinafter as “those skilled in the art”) from the detailed description of the embodiments.

In one aspect, the present disclosure provides an in-wheel motor including a stator, a rotor rotatably disposed relative to the stator, and a seal connected to the stator and disposed to be in contact with a part of the rotor. In particular, the part of the rotor includes a coated surface.

In another aspect, the present disclosure provides an in-wheel motor including a stator, a rotor rotatably disposed relative to the stator, and a seal connected to the stator and disposed to be in contact with a part of the rotor by at least one lip of the seal. In particular, the at least one lip is surface treated.

Other aspects and embodiments of the disclosure are discussed below.

It is understood that the terms “vehicle,” “vehicular,” and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are further discussed below.

### BRIEF DESCRIPTION OF THE DRAWINGS

The above and other features of the present disclosure are now described in detail with reference to embodiments thereof illustrated in the accompanying drawings which are given hereinbelow by way of illustration only, and thus are not limitative of the present disclosure, and wherein:

FIG. 1 is a cross-sectional view along the axial or y-axis direction of an in-wheel motor in an embodiment and illustrates a half part of the in-wheel motor rotating around an axis C;

FIG. 2 is a cross-sectional view along the axial or y-axis direction of an in-wheel motor according to some embodiments of the present disclosure;

FIG. 3 is an enlarged view of a part S1 of FIG. 2;

FIG. 4 is a partially enlarged view of FIG. 3;

FIG. 5 is a view showing a slinger and a dust cover of the in-wheel motor according to some embodiments of the present disclosure;

FIG. 6 is a view showing a surface state of an opposite side surface of the slinger according to some embodiments of the present disclosure;

FIG. 7 is a view showing the slinger and the dust cover of the in-wheel motor according to some embodiments of the present disclosure;

FIG. 8 is a view showing a flow of grease between a seal and the slinger during high speed rotation of the in-wheel motor;

FIG. 9 is a cross-sectional view of the in-wheel motor according to some embodiments of the present disclosure;

FIG. 10 is a view showing a sliding surface of the slinger of the in-wheel motor according to some embodiments of the present disclosure;

FIG. 11 is a view showing the slinger of the in-wheel motor according to some embodiments of the present disclosure, including a plate attached to the sliding surface;

FIG. 12 is a side view of FIG. 11;

FIG. 13 is a view showing an inner seal including a surface treated lip of the in-wheel motor according to some embodiments of the present disclosure;

FIG. 14 is a cross-sectional view of an outer seal and the slinger of the in-wheel motor according to some embodiments of the present disclosure;

FIG. 15 is a view showing a result of evaluating friction/wear characteristics of each material of the slinger through a reciprocating friction and wear tester;

FIG. 16 is a view showing frictional force according to revolutions per minute in the case of a coated slinger and an uncoated slinger;

FIG. 17 is a view showing a temperature change of the outer seal over time in the case of the coated slinger and the uncoated slinger;

FIG. 18 is a view showing the maximum revolutions per minute of a motor depending on a wheel size in consideration of a case in which the slinger according to the present disclosure is surface treated and a comparative case in which the slinger is not coated;

FIG. 19 is a view showing a result of evaluating a surface-treated lip and a non-surface-treated lip through the reciprocating friction and wear tester; and

### DETAILED DESCRIPTION

Specific structural or functional descriptions given in connection with the embodiments of the present disclosure are merely illustrative for the purpose of describing embodiments according to the concept of the present disclosure, and the embodiments according to the concept of the present disclosure may be implemented in various forms. Further, it should be understood that the present description is not intended to limit the disclosure to the embodiments. On the contrary, the disclosure is intended to cover not only the embodiments, but also various alternatives, modifications, equivalents, and other embodiments, which may be included within the spirit and scope of the disclosure as defined by the appended claims.

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a in second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to,” should be interpreted in the same manner.

When a component, device, element, or the like of the present disclosure is described as having a purpose or performing an operation, function, or the like, the component, device, or element should be considered herein as being “configured to” meet that purpose or to perform that operation or function.

The same reference numerals represent the same components throughout the specification. Additionally, the terms in the specification are used merely to describe embodiments and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

Hereinafter, the present disclosure is described in detail with reference to the accompanying drawings.

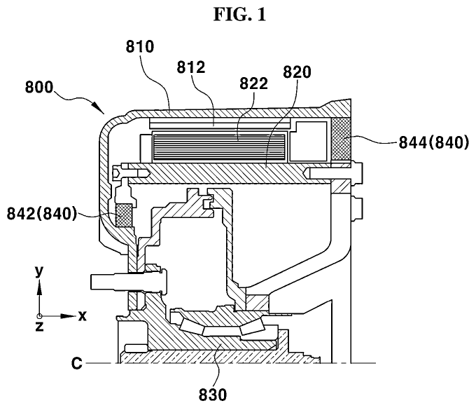

As shown in FIG. 1, an in-wheel motor 800 includes a rotor 810 and a stator 820. The rotor 810 is configured to rotate relative to the stator 820 by electromagnetic interaction between the rotor 810 and the stator 820. In one embodiment, the rotor 810 may include a permanent magnet 812, and the stator 820 may have a coil 822 wound around the stator 820. When a current is applied to the coil 822 and is magnetized, the rotor 810 may rotate while being rotatably supported by a bearing 830 through interaction with the permanent magnet 812.

In one embodiment, a seal 840 is provided between the rotor 810 and the stator 820. The seal 840 may include an outer seal 842 disposed on the outer side of a wheel installed on a vehicle and an inner seal 844 located closer to the inner side of the vehicle than the outer seal 842, when the in-wheel motor 800 is mounted on the wheel of the vehicle. Generally, the diameter of the inner seal 844 is larger than that of the outer seal 842, and the diameter of the inner seal 844 may be similar to the diameter of the rotor 810 or the wheel. The seal 840 may prevent moisture, foreign substances, and the like from intruding into the in-wheel motor 800.

When the in-wheel motor 800 is installed in a vehicle as described above. Particularly, when the in-wheel motor 800 is installed in a vehicle including four or more wheels, there are various design conditions to be considered in designing the seal 840 in view of characteristics of the in-wheel motor 800 disposed in the wheel.

For example, the seal 840 may be mounted on the wheel and directly exposed to the external environment. In a cold region, the in-wheel motor 800 may be exposed to a rapid temperature change during startup. For example, when the outside temperature is about minus 40 degrees Celsius and the in-wheel motor 800 is started, the in-wheel motor 800 may be exposed to frictional heat of about 160 degrees Celsius. Additionally, the seal 840 is directly exposed to vibration, shock, moisture, foreign substances, and the like, and may be submerged in water.

Further, since parts having the seal 840 interposed therebetween are made of different materials, a gap may change depending on a difference in thermal and/or mechanical deformation.

Additionally, a large diameter seal (for example, the inner seal 844) is required for an outer rotor type in-wheel motor in which a rotor is disposed on the outer side of a stator. For example, when the wheel diameter is equal to or greater than 16 inches, the outer diameter of the seal 840 needs to be equal to or greater than approximately 350 mm. The maximum linear speed of the seal 840 may exceed 30 meters per second based on the vehicle speed of more than 200 kilometers per hour. In case of the outer rotor type in-wheel motor, excessive friction may occur in the seal 840 due to high linear speed, which may cause deterioration in performance of the in-wheel motor 800 and damage to the seal 840.

Therefore, the seal 840 needs to be dustproof, waterproof, and made of a low friction material and a low wear material. Further, the seal 840 needs to withstand a combination of different materials. In addition, the seal 840 needs to prevent moisture and foreign substances from intruding into the in-wheel motor 800 and to discharge water condensed in the in-wheel motor 800. Moreover, the seal 840 needs to have excellent durability so that frequent replacement thereof is not required.

The present disclosure provides a sealing device for an in-wheel motor that has basic and essential sealing force of a seal and considers characteristics of an outer rotor type in-wheel motor. Additionally, the present disclosure provides an in-wheel motor capable of implementing low friction sealing and/or low wear sealing.

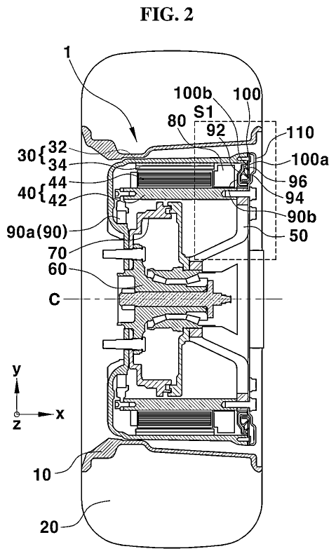

Referring to FIG. 2, an in-wheel motor 1 according to the present disclosure may be mounted in a wheel 10 of a vehicle. The x-axis direction refers to the lateral direction of the vehicle, the z-axis direction refers to the longitudinal direction of the vehicle, and the y-axis direction refers to the vertical direction of the vehicle. Additionally, in the in-wheel motor 1 in FIG. 2, the left side is the outer side of the vehicle, and the right side is the inner side of the vehicle. Accordingly, the in-wheel motor 1 shown in FIG. 2 is installed in the wheel on the driver's seat side of the vehicle. Undescribed reference numeral 20 indicates a tire mounted on the wheel 10.

The in-wheel motor 1 is configured to be rotatable within the wheel 10 to directly rotate the wheel 10. To this end, the in-wheel motor 1 includes a rotor 30 serving as a rotating part and a stator 40 serving as a fixed part.

In one embodiment, the in-wheel motor 1 may be an outer rotor type motor in which the rotor 30 is disposed radially outward relative to the stator 40. The rotor 30 includes a rotor housing 32 and a first magnetic member 34 mounted on the rotor housing 32 to be rotatable relative to the stator 40. The stator 40 serving as a fixed part is connected to a vehicle by a support bracket 50 and includes a stator housing 42 and a second magnetic member 44 coupled to the stator housing 42.

In some embodiments, both the first magnetic member 34 and the second magnetic member 44 may be electromagnets in which wires are wound around the rotor 30 and the stator 40, respectively, in a coil shape. In some implementations, any one of the first magnetic member 34 and the second magnetic member 44 may be a permanent magnet, and the other one may be an electromagnet. In one embodiment, the first magnetic member 34 may be a permanent magnet, and the second magnetic member 44 may be an electromagnet. Hereinafter, a description is given as to an example in which the first magnetic member 34 of the rotor 30 is a permanent magnet and the second magnetic member 44 is an electromagnet.

The first magnetic member 34 and the second magnetic member 44 may electromagnetically interact by magnetization of the second magnetic member 44 of the stator 40. The rotor 30 including the first magnetic member 34 is configured to be rotatable around an axis C of the wheel 10 relative to the stator 40 including the second magnetic member 44. A wheel bearing 60 connects the wheel 10, the rotor housing 32, and a brake 70, and is rotatable relative to the stator 40. The brake 70 may be disposed radially outside the wheel bearing 60 and may be operably coupled to the in-wheel motor 1.

The in-wheel motor 1 also includes a high temperature and high voltage part 80. The high temperature and high voltage part 80 may be located in the stator 40. As a non-limiting example, the high temperature and high voltage part 80 may include a bus bar configured to connect the second magnetic member 44, which is a coil of the stator 40, to a power source, electrical components required to drive the in-wheel motor 1, and the like. Therefore, the high temperature and high voltage part 80 is a high voltage and high temperature component of the in-wheel motor 1. For example, temperature of the high temperature and high voltage part 80 may reach about 180 degrees Celsius, and voltage thereof may reach about 700 volts.

Referring to FIG. 2, the first magnetic member 34 is disposed radially inside the rotor housing 32, and the stator housing 42 having the second magnetic member 44 wound therearound is disposed radially inside the first magnetic member 34. In this case, a gap is present between the rotor 30 and the stator 40. The wheel bearing 60 and the brake 70 may be disposed concentrically with the stator 40 radially inside the stator 40, and the wheel bearing 60 and the brake 70 may be coupled to the rotor housing 32 to be rotatable with rotation of the wheel 10. One end of the rotor housing 32 is closed except for the center of the rotor housing 32, and the support bracket 50 connected to the vehicle is inserted into the stator 40 and is coupled to the wheel bearing 60 at the other end of the rotor housing 32. After the rotor 30 and the stator 40 are coupled to each other, a space between the rotor 30 and the stator 40 needs to be sealed.

To this end, the in-wheel motor 1 is sealed by a sealing device or an annular seal 90. Specifically, the space between the rotor 30 and the stator 40 is sealed by the seal 90 on the opposite sides of the x-axis direction or the axial direction of the rotor 30 and the stator 40. In one embodiment, the seal 90 includes an outer seal 90a disposed at the outer side of the vehicle in the lateral direction (i.e., “x” direction) and an inner seal 90b disposed closer to the center of the vehicle. As a non-limiting example, the seal 90 may be made of a rubber material. In this case, the inner seal 90b may include a structure 92 embedded therein to maintain the shape of the inner seal 90b. As a non-limiting example, the structure 92 may be made of steel. The structure 92 may have a shape similar to that of the inner seal 90b to extend along the interior of the inner seal 90b.

According to an embodiment of the present disclosure, a sealing device according to some embodiments of the present disclosure may be configured as follows in order for the inner seal 90b disposed adjacent to the high temperature and high voltage part 80 to satisfy the above-described design conditions. In the present disclosure, the inner seal 90b refers to a large diameter seal indicating an outer diameter of at least 350 mm, and the inner seal 90b may be disposed at the location of the outer seal 90a. In other words, the term “the inner seal 90b” is intended to refer to a large diameter seal in the illustrated embodiment and is not intended to limit the location of the seal on the wheel.

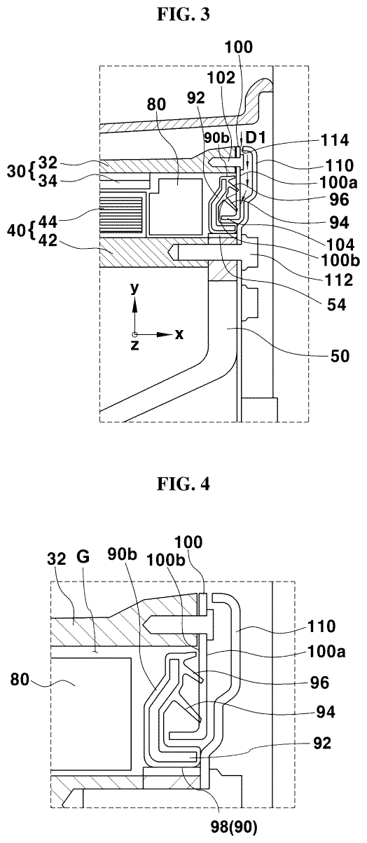

As shown in FIG. 3, the inner seal 90b may be connected to the stator 40. In some embodiments, the inner seal 90b may be connected to the stator 40 via the support bracket 50. In some embodiments, the inner seal 90b and the support bracket 50 may be assembled or integrated with each other to form one module, and then the module may be assembled with the stator 40. In one embodiment, the inner seal 90b may be formed in an annular shape and may be fixed to an outer peripheral portion 54 of the support bracket 50. Specifically, the inner seal 90b and the support bracket 50 may be integrated with each other by assembling an inner peripheral portion 98 of the inner seal 90b with the outer peripheral portion 54 of the support bracket 50.

When the sealing device is configured in this manner, the space occupied by the inner seal 90b and the support bracket 50 with respect to the in-wheel motor 1 may be minimized, thereby making it possible to further secure an internal space of the in-wheel motor 1 and a chassis connection space of the vehicle. For example, connection of a bus bar located in the in-wheel motor 1 or connection with a suspension located outside the in-wheel motor 1 may be more easily performed.

The inner seal 90b is mounted on the stator 40 to have a gap G of a predetermined distance from the rotor 30. The gap G allows the rotor 30 to freely rotate without interference. However, since moisture, foreign substances, and the like may flow into the in-wheel motor 1 through the gap G, an annular slinger 100 is mounted on the rotor 30. The slinger 100 directly blocks or cover the gap G to extend a movement path of moisture or foreign substances flowing into the in-wheel motor 1 from the outside, thereby preventing the moisture or the foreign substances from flowing into the in-wheel motor 1.

The slinger 100 is coupled to the end of the rotor 30. The slinger 100 extends in the circumferential direction of the rotor 30 and extends toward the inner side of the rotor 30 in the radial direction to extend between the rotor 30 and the stator 40. In this manner, the slinger 100 is configured to at least partially overlap the inner seal 90b disposed between the rotor 30 and the stator 40 in the radial direction.

The slinger 100 is coupled to the rotor housing 32 by a coupling member 102. As a non-limiting example, the coupling member 102 may be a bolt. A hole 108 may be provided in the slinger 100. The hole 108 may be provided around the circumference of the slinger 100, and the coupling member 102 may be inserted into the hole 108. The slinger 100 is coupled to the rotor 30 through the coupling member 102, thereby reinforcing rigidity of the rotor 30 and facilitating disassembly and assembly of the slinger 100. Accordingly, since the slinger 100 is recyclable, the slinger 100 is used as an environmentally friendly member, and manufacturing costs thereof are reduced. Moreover, since the slinger 100 may be easily separated from and assembled with the coupling member 102, maintenance thereof may be easily performed. In an embodiment, the slinger 100 is made of steel having high thermal conductivity and is combined at the end of the rotor 30 or outside the space between the rotor 30 and the stator 40. Accordingly, the slinger 100 is configured to easily dissipate, to the outside, heat caused by contact friction with the inner seal 90b, thereby preventing a temperature rise of the inner seal 90b adjacent to the high temperature and high voltage part 80. Since cooling of the inner seal 90b is smoothly performed, seal deformation and deterioration may be suppressed, and durability of the inner seal 90b may be improved. In addition, the inner seal 90b made of rubber or resin is located between the high temperature and high voltage part 80 and the slinger 100 made of steel, thereby serving as an insulator and preventing internal discharge.

In one embodiment, the slinger 100 may include a bent portion 104. As described above, the slinger 100 generally extends in the y-axis direction or the radial direction of the in-wheel motor 1. In another embodiment, the bent portion 104, formed to bend toward the inner seal 90b, is provided at the end of the slinger 100. As described below, the bent portion 104 may extend the movement path of foreign substances flowing into the in-wheel motor 1.

Additionally, with reference to FIG. 4, the seal 90 includes lips 94 and 96. In some embodiments, one lip may be provided on the seal 90. In other words, the seal 90 includes at least one lip.

According to some embodiments of the disclosure, the seal 90 or the inner seal 90b includes at least two lips 94 and 96. In one embodiment, the seal 90 may include the upstream lip 94 and the downstream lip 96. The upstream lip 94 is disposed upstream in an intrusion direction D1 of foreign substances, and the downstream lip 96 is disposed downstream of the upstream lip 94. The two lips 94 and 96 may additionally prevent intrusion of foreign substances with a maze structure described below.

At least one of the lips 94 and 96 may be disposed to contact the slinger 100. In some embodiments, only one of the upstream lip 94 and the downstream lip 96 may contact the slinger 100. For example, the upstream lip 94 may be formed of a contact lip with the slinger 100, and the downstream lip 96 may be disposed only to contact the slinger 100 with an overlapping amount or a clamping amount of zero (“0”) or may be disposed not to contact the slinger 100. Alternatively, the opposite is also possible. In some embodiments, both the upstream lip 94 and the downstream lip 96 may be disposed to contact the slinger 100.

In one embodiment, the lips 94 and 96 may be formed obliquely toward the center of the in-wheel motor 1 to contact the slinger 100. Particularly, the lips 94 and 96 are disposed to be inclined toward the intrusion direction D1 of foreign substances. The shapes of the lips 94 and 96 prevent the lips 94 and 96 from being easily bent in the intrusion direction D1, thereby preventing foreign substances from easily flowing into the in-wheel motor 1.

According to an embodiment of the present disclosure, all of the lips 94 and 96 are configured to face outward in the axial direction (x-axis direction) of the in-wheel motor 1. Since the slinger 100 is disposed at the end of the in-wheel motor 1, the lips 94 and 96 may face outward in the axial direction of the in-wheel motor 1. As a result, the lips 94 and 96 are disposed on the opposite side of the high temperature and high voltage part 80 of the in-wheel motor 1 and, as such, heat transfer of the high temperature and high voltage part 80 may be reduced and heat dissipation due to seal friction may be easily performed. Heat transfer inside the in-wheel motor 1 may be suppressed by the increased distance between the high temperature and high voltage part 80 and the lips 94 and 96, and cooling performance of the inner seal 90b is improved, thereby suppressing deformation and deterioration of the inner seal 90b and improving durability of the inner seal 90b.

A dust cover 110 may be disposed on the outer side of the slinger 100. The dust cover 110 is coupled to the stator 40. Specifically, the dust cover 110 is coupled to the stator housing 42. The dust cover 110 may be coupled to the stator 40 through a coupling member 112, such as a bolt. Since the dust cover 110 is detachably coupled to the stator 40 by the coupling member 112, disassembly and assembly may be easily performed, thereby facilitating maintenance. Additionally, since the dust cover 110 is recyclable, the dust cover 110 is used as an environmentally friendly member, and manufacturing costs thereof are reduced.

The dust cover 110 is coupled to the in-wheel motor 1 at the outer side of the inner seal 90b and the slinger 100 to prevent the inner seal 90b and the slinger 100 from being separated from each other. That is, the dust cover 110 may serve as a stopper to prevent the inner seal 90b from being pushed out of the in-wheel motor 1 and may improve durability by providing improved fixing force to the inner seal 90b.

The dust cover 110 includes a passage 114. The passage 114 may refer to a small gap between a peripheral portion of the dust cover 110 and the slinger 100. The passage 114 may additionally discharge, to the outside, foreign substances flowing into the dust cover 110 and may provide a maze structure to the sealing device.

Specifically, the dust cover 110 may initially prevent foreign substances, such as moisture, from flowing into the in-wheel motor 1. When foreign substances flow into the dust cover 110 through the passage 114, the foreign substances may not move in the axial direction of the in-wheel motor 1 because the slinger 100 extends in the radial direction of the in-wheel motor 1. As a result, the foreign substances move in the intrusion direction D1. Even if foreign substances reach between the inner seal 90b and the slinger 100, further intrusion thereof is prevented by the lips 94 and 96. In addition, according to the present disclosure, at least two lips, that is, the upstream lip 94 and the downstream lip 96 are provided. Accordingly, even if the upstream lip 94 is damaged, intrusion of foreign substance may be secondarily blocked by the downstream lip 96. Further, the intruded foreign substances may move in a direction opposite the intrusion direction D1 while the in-wheel motor 1 rotates, thereby being additionally discharged to the outside of the dust cover 110.

According to some embodiments of the present disclosure, the sealing device may further include a structure that enables heat dissipation with respect to sliding heat generated by the rotating seal 90. If the heat dissipation of the seal 90 is not easily performed, temperature may rapidly rise due to destruction of lubrication of a sliding part when heat resistance temperature of materials, such as lips and grease, is exceeded, which may result in damage to the seal 90. However, the sealing device according to the present disclosure enables effective cooling of the seal 90. Furthermore, the present disclosure may prevent deterioration in heat dissipation that may occur when the maze structure using the inner seal 90b, the slinger 100, and the dust cover 110 is applied to the sealing device.

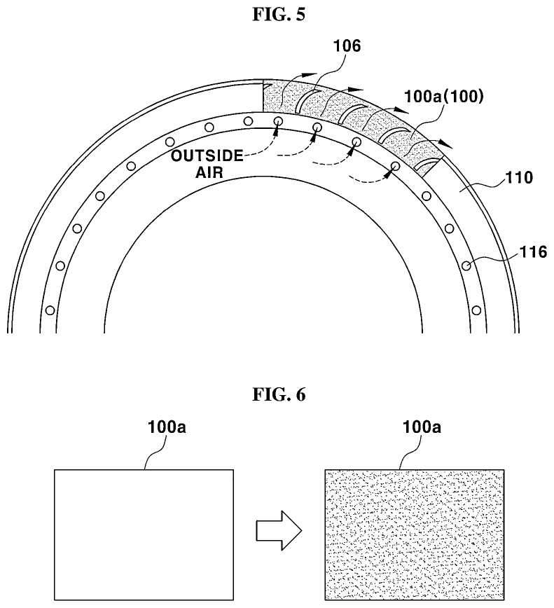

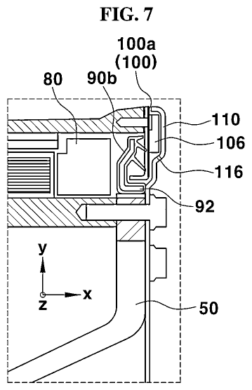

Referring to FIGS. 5 to 7, according to one embodiment, the slinger 100 may be surface treated. Specifically, an opposite side surface 100a of the slinger 100 facing the dust cover 110 may be surface treated to obtain surface roughness having a predetermined value or more. A sliding surface 100b, which is a surface in contact with the lips 94 and 96, is maintained as it is, and as shown in FIG. 6, the opposite side surface 100a of the slinger 100 facing the dust cover 110 is configured to have a large surface roughness. As a non-limiting example, the surface roughness of the opposite side surface 100a of the slinger 100 may be increased through sand blasting.

Increased roughness of the opposite side surface 100a may increase a heat dissipation surface area of the slinger 100, thereby improving a convective heat transfer coefficient. Accordingly, it is possible to increase heat dissipation efficiency and ultimately suppress temperature rise of the seal 90. Additionally, by lowering the maximum operating temperature of the inner seal 90b, deformation and deterioration of the inner seal 90b may be suppressed, thereby improving durability of the inner seal 90b.

In some embodiments, one or more vanes 106 capable of promoting ventilation and suppressing intrusion of foreign substances may be formed on the opposite side surface 100a of the slinger 100. The vanes 106 may be provided to be spaced apart from each other by a predetermined distance in the circumferential direction of the slinger 100.

According to the present disclosure, a centrifugal pump function may be implemented by forming the vanes 106 on the opposite side surface 100a of the slinger 100. Here, the opposite side surface 100a is a surface in contact with outside air. The vanes 106 are provided to prevent foreign substances from flowing into a space between the slinger 100 and the dust cover 110 and to facilitate discharge of the introduced foreign substances. The vanes 106 may facilitate ventilation and accelerate internal heat dissipation of the in-wheel motor 1. The accelerated heat dissipation suppresses the temperature rise of the seal 90 and reduces the maximum operating temperature of the seal 90, thereby suppressing deformation and deterioration of the seal 90 and improving durability thereof. Additionally, rotation of the vanes 106 may prevent foreign substances from flowing into the dust cover 110 and may facilitate discharge of foreign substances.

According to some embodiments of the present disclosure, the dust cover 110 may include one or more vent holes 116. The one or more vent holes 116 may be provided in the circumferential direction of the dust cover 110.

The vent holes 116 may enable inflow of outside air to perform active ventilation. In other words, the vent holes 116 may facilitate heat dissipation inside the in-wheel motor 1 and may prevent temperature rise of the seal 90.

According to the present disclosure, the sealing device may include a structure capable of reducing friction between the slinger 100 serving as a rotating part of the in-wheel motor and the seal 90 serving as a fixed part.

Through this structure, the sealing device according to the present disclosure may be reliably used in an outer rotor type in-wheel motor adopted to drive an electric vehicle and may provide a large diameter seal capable of responding to a high linear speed.

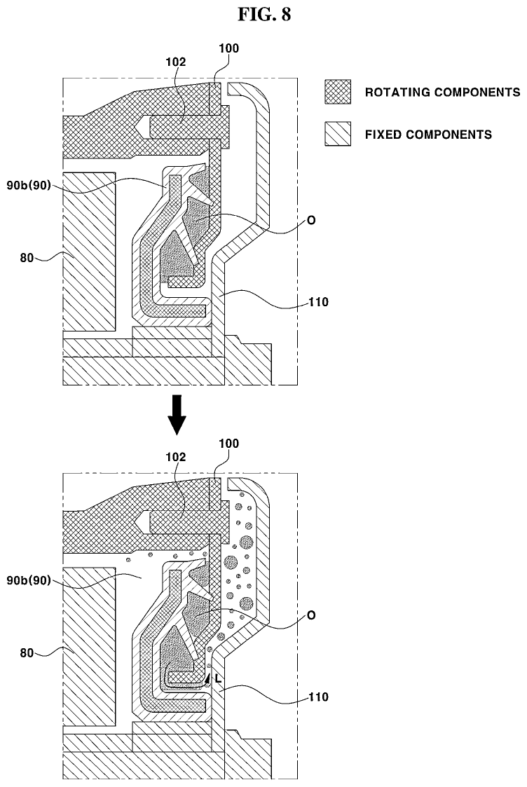

When the rotor 30 rotates at high speed, friction between the large-diameter seal and the slinger 100 increases due to the high linear speed of the large-diameter seal, leading to heat generation and wear. For example, as the outer diameter of the inner seal 90b increases, circumferential speed increases and friction increases. Increased friction may cause deterioration in fuel efficiency of an electric vehicle. Additionally, heat is generated due to increased friction, and wear of the inner seal 90b increases. As a result, a replacement cycle of the inner seal 90b is shortened and durability of the inner seal 90b deteriorates. A damage process of the seal 90 is described with reference to FIG. 8.

Referring to FIG. 8, grease “O” is filled in a space between the inner seal 90b and the slinger 100. Heat is generated by friction between the inner seal 90b and the slinger 100 during high speed rotation of the rotor 30. This heat causes temperature rise of the inner seal 90b and the grease O and generates flowability in the grease O. The grease O having flowability may escape from the space between the inner seal 90b and the slinger 100, and a leak “L” may be generated toward the dust cover 110. When an amount of grease O in the space between the inner seal 90b and the slinger 100 decreases, friction and wear of the inner seal 90b are accelerated, resulting in overheating due to insufficient lubrication. As a result, white smoke may occur, and the inner seal 90b may be damaged.

Accordingly, the sealing device according to the present disclosure may include a structure capable of preventing the above-described problem and reducing friction of the seal 90.

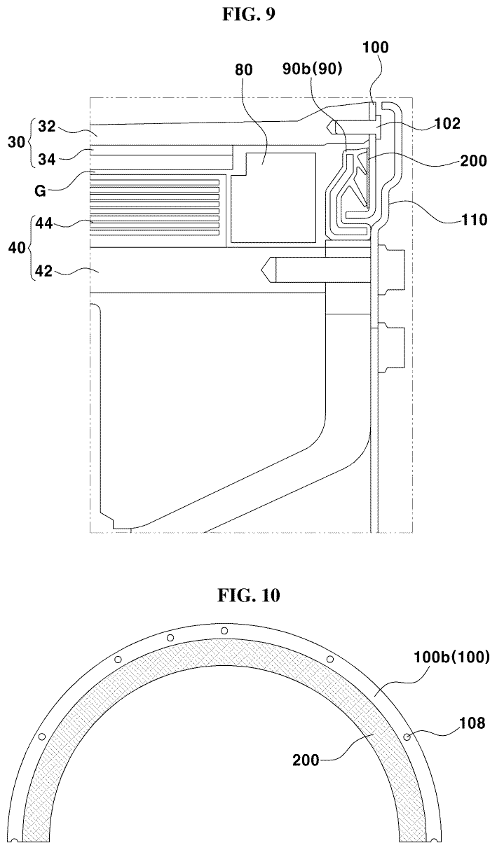

Referring to FIGS. 9 and 10, according to an embodiment of the present disclosure, the sliding surface 100b of the slinger 100 may be surface treated. The sliding surface 100b is a surface in contact with the lips 94 and 96 of the inner seal 90b, and a coating surface 200 having low friction properties and low wear properties may be applied to the sliding surface 100b. As a non-limiting example, a material of the coating surface 200 having low friction properties and low wear properties may include a polymer, diamond-like carbon (DLC), or a combination thereof. In one example, the polymer may include a fluorine-based polymer and may include polytetrafluoroethylene (PTFE). In one embodiment, the polymer may be coated to a thickness of at least 30 micrometers or more. When the thickness of coating is 30 micrometers or more, it is possible to drive the in-wheel motor for 300,000 kilometers which is a target durability lifespan of the in-wheel motor.

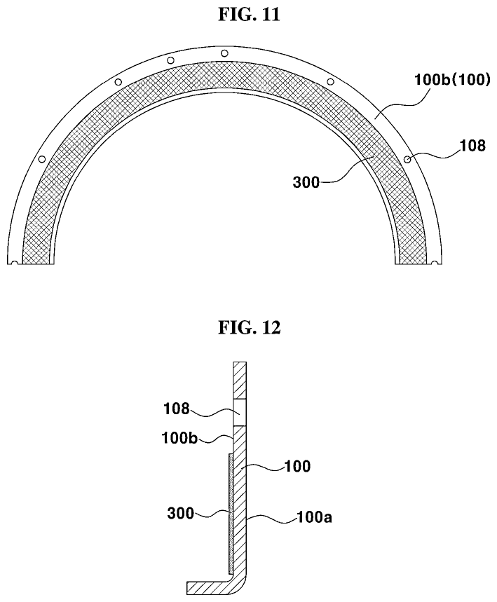

Referring to FIGS. 11 and 12, according to some embodiments of the present disclosure, a separate plate 300 may be attached to the sliding surface 100b of the slinger 100. In one example, the plate 300 may have an annular shape. The plate 300 may be attached to the sliding surface 100b of the slinger 100 to be in contact with the lips 94 and 96 of the inner seal 90b.

The plate 300 is made of a material capable of reducing friction. For example, the plate 300 may be coated with an engineering polymer coating having higher hardness than that of a polymer coating. In one example, the plate 300 may be made of polyetheretherketone (PEEK).

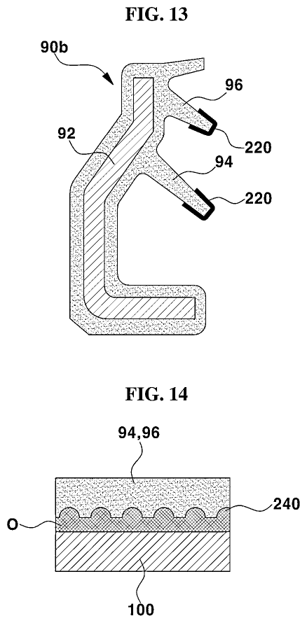

Referring to FIG. 13, according to an embodiment of the present disclosure, the lips 94 and 96 of the inner seal 90b may be surface treated. In one example, the upstream lip 94 may be surface treated. In another example, the downstream lip 96 may be surface treated. In still another example, both the upstream lip 94 and the downstream lip 96 may be surface treated. In particular, portions of the lips 94 and 96 that may be in contact with the sliding surface 100b of the slinger 100 may be surface treated. Through this surface treatment, friction between the surfaces of the lips 94 and 96 and the sliding surface 100b of the slinger 100 may be reduced.

According to one embodiment of the present disclosure, surface treatment of the lips 94 and 96 may be performed by forming a coating surface 220 on each of the lips 94 and 96. As a non-limiting example, the material of the coating surface 220 that enables low friction and low wear may include a polymer or diamond-like carbon (DLC). In one example, the polymer may include a fluorine-based polymer and may include polytetrafluoroethylene (PTFE).

As shown in FIG. 14, the lips 94 and 96 may include a pocket 240. The pocket 240 may be formed on portions of the lips 94 and 96 in contact with the slinger 100. In one example, the pocket 240 may be formed as a micro-dimple by sanding or the like. As in the case of the coating surface 220, the pocket 240 formed on the lips 94 and 96 may reduce friction between the lips 94 and 96 and the slinger 100.

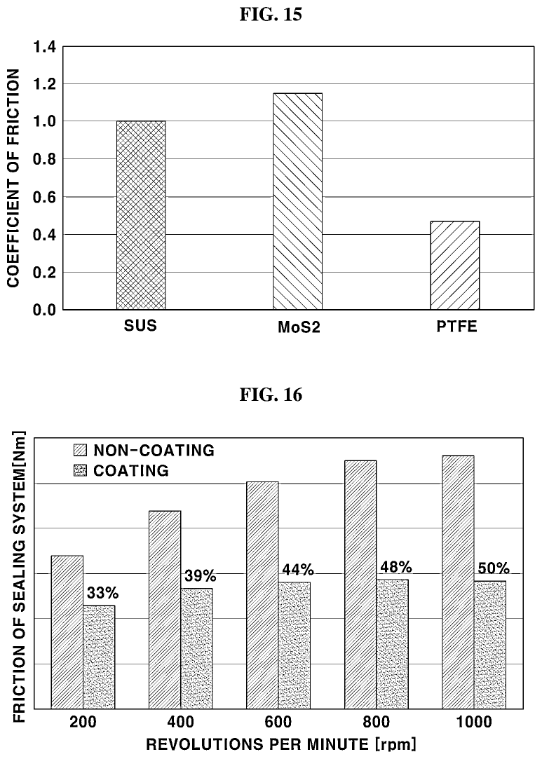

As shown in FIG. 15, friction and wear characteristics of a slinger made of SUS, a slinger made of MoS₂, and a slinger surface-treated with PTFE were evaluated using a reciprocating friction and wear tester. In the case of the slingers made of SUS and MoS₂ under dry conditions (insufficient lubrication environment), the test ended early due to a rapid increase in friction. However, in the case of the slinger made of PTFE, it was confirmed that a low friction effect was exhibited from initial startup due to a low coefficient of friction. Additionally, as shown in FIG. 16, it was confirmed that rotational friction was reduced by up to 50% in the case of the slinger coated with PTFE, as compared with an uncoated slinger.

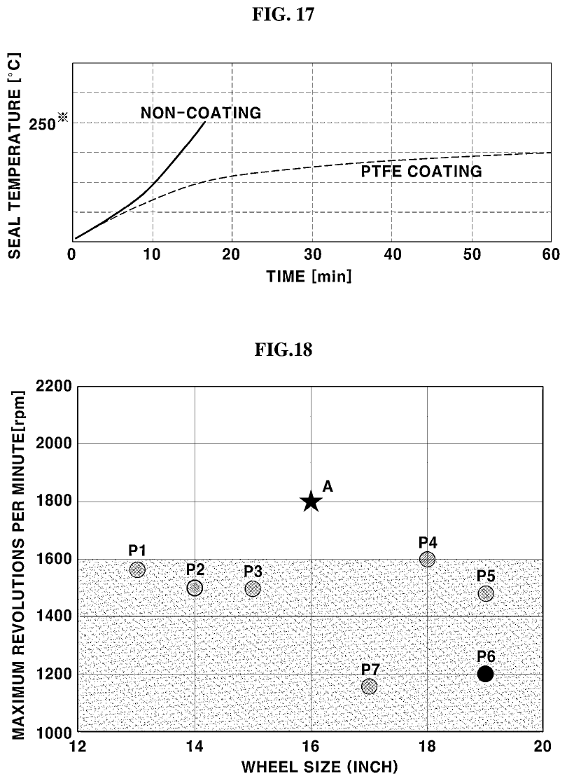

Durability of the uncoated slinger and the slinger coated with PTFE was evaluated in a continuous driving test environment at the highest speed (vehicle speed of 215 kilometers per hour, 31 meters per second of circumferential speed of the inner seal 90b). Referring to FIG. 17, it may be seen that heat generation of the slinger coated with PTFE is significantly improved as compared with the uncoated slinger (250 degrees Celsius is the temperature limit for use of fluorine kautschuk material (FKM) fluoride rubber. As shown in Table 1, it may be seen that the maximum revolutions per minute capable of continuously driving the in-wheel motor is improved by a low friction effect, and continuous output is improved.

TABLE 1

| Classification | Continuous output of in-wheel motor |
|---|---|
| Uncoated | 54 kilowatts @ 900 RPM (revolutions per minute) |
| PTFE coating | 76 kilowatts @ 1200 RPM |
| Improvement rate | 40% |

Additionally, as shown in FIG. 18, compared to various comparative examples (P1 to P7) in which the slinger was not surface treated, the maximum revolutions per minute of the motor is improved in the case of the present disclosure A.

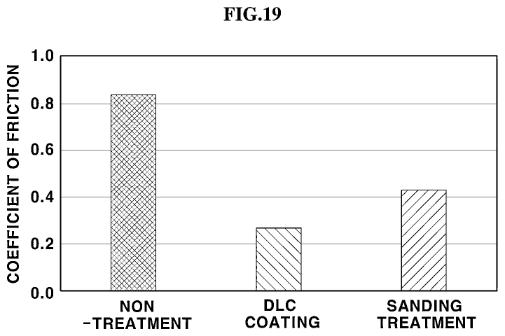

In addition, friction and wear characteristics of an untreated lip without coating or a pocket, a lip with DLC coating, and a lip with a pocket were evaluated using a reciprocating friction and wear tester. As shown in FIG. 19, in the case of no treatment under dry conditions (insufficient lubrication environment), the test ended early due to a rapid increase in friction. However, it was confirmed that the lip with DLC coating or the lip with the pocket showed a low friction and low wear effect due to a low coefficient of friction. It was confirmed that a coefficient of friction was reduced by up to 68% in the case of the lip with DLC coating, as compared with the lip without coating. Additionally, it was confirmed that, in the case of the lip with the pocket, the coefficient of friction was reduced by up to 49% due to reduction of a contact area, as compared with the lip without coating. In the case of the lip with the pocket, it is expected that, when lubrication is performed with grease O, the dimple shape formed on the surface of the lips 94 and 96 may function as a pocket of grease to further reduce friction.

In this manner, friction is improved in the in-wheel motor including the lips 94 and 96 with surface treatment and/or the slinger 100 of the present disclosure. It was confirmed that efficiency of a low load region of the in-wheel motor can be improved by approximately 4 to 5 percent, based on a computer-based structural analysis, through which efficiency for each load area of the in-wheel motor including the surface-treated slinger was obtained. Therefore, according to the present disclosure, efficiency of the in-wheel motor may be improved and, as such, fuel efficiency of an electric vehicle is improved.

According to the present disclosure, a low friction and/or low wear sealing device and an in-wheel motor including the same are provided.

According to the present disclosure, a sealing device having improved durability and an in-wheel motor including the same are provided.

According to the present disclosure, a sealing device capable of improving efficiency of a motor and fuel efficiency of an electric vehicle and an in-wheel motor including the same are provided.

According to the present disclosure, the dust cover 110 including the bent portion 104, the slinger 100, and the inner seal 90b form a maze structure so as to make a movement path of foreign substances complicated, thereby providing excellent sealing force by substantially blocking inflow of foreign substances. Additionally, since the maze structure starts from the dust cover 110 and a filter function is implemented, sealing performance may be improved. Accordingly, sealing burden of the lips 94 and 96 is reduced, thereby further reducing friction.

In general, a seal of an in-wheel motor is disposed close to high temperature and high voltage components, such as the high temperature and high voltage part 80, due to a structure of the in-wheel motor 1 and is exposed to significantly high temperature. When a seal has a large diameter, the seal may be exposed to frictional heat and wear due to particularly high circumferential speed. However, according to the sealing device according to the present disclosure, since the lips 94 and 96 of the inner seal 90b are disposed in a state of facing the opposite side of the high temperature and high voltage part 80, damage due to temperature is prevented, thereby effectively responding to frictional heat and wear caused by high circumferential speed. According to the present disclosure, it is possible to effectively deal with heat generation caused by motor losses such as copper loss, magnet loss, and iron loss.

According to the present disclosure, since the inner seal 90b is disposed between the high temperature and high voltage part 80 serving as a high voltage part and the slinger 100 made of steel, it is possible to provide excellent insulation against the internal high voltage of the in-wheel motor 1 by blocking discharge to a steel component such as the slinger 100.

According to the present disclosure, the sealing device may support the large-diameter rotor 30 and suppress deformation thereof by using the slinger 100 as a structure.

According to the present disclosure, the inner seal 90b and the support bracket 50 may be modularized, thereby providing extra space to the narrow in-wheel motor 1.

Additionally, according to the present disclosure, a sealing device having excellent heat dissipation performance against sliding heat generation is provided.

According to the present disclosure, although the sealing device has been described as a device applied to the in-wheel motor, the sealing device may be applied to a space between any fixed body and any rotating body where a sealing device is required, in addition to the in-wheel motor.

As is apparent from the above description, the present disclosure provides a sealing device capable of providing excellent sealing force.

Further, the present disclosure provides a sealing device optimized for characteristics of an in-wheel motor and an in-wheel motor including the same.

Additionally, the present disclosure provides a low friction and/or low wear sealing device and an in-wheel motor including the same.

In addition, the present disclosure provides a sealing device having improved durability and an in-wheel motor including the same.

Furthermore, the present disclosure provides a sealing device capable of improving efficiency of a motor and fuel efficiency of an electric vehicle and an in-wheel motor including the same.

The effects of the present disclosure are not limited to the above-mentioned effects, and other effects not mentioned herein should be clearly understood by those skilled in the art from the detailed description of the embodiments.

The present disclosure described above is not limited to the above-described embodiments and the accompanying drawings. However, it should be appreciated by those having ordinary skilled in the art that changes may be made in these embodiments without departing from the principles and spirit of the disclosure, the scope of which is defined in the appended claims and equivalents thereto.

What is claimed is:

1. An in-wheel motor comprising:
a stator;
a rotor rotatably disposed relative to the stator; and
a seal connected to the stator and disposed to be in contact with a part of the rotor,
wherein the part of the rotor comprises a coated surface.

2. The in-wheel motor of claim 1, wherein the coated surface is formed of a fluorine-based polymer, polyetheretherketone (PEEK), diamond-like carbon (DLC), or any combination thereof.

3. The in-wheel motor of claim 1, wherein the coated surface is formed on a plate separately attached to the part of the rotor.

4. The in-wheel motor of claim 3, wherein the plate is formed of a polymer.

5. The in-wheel motor of claim 4, wherein the plate is formed of polyetheretherketone (PEEK).

6. The in-wheel motor of claim 1, wherein the part of the rotor is a slinger coupled to the rotor.

7. The in-wheel motor of claim 6, wherein the slinger comprises:
a sliding surface configured to contact the seal; and
an opposite side surface formed on an opposite side of the sliding surface.

8. The in-wheel motor of claim 7, wherein the coated surface is formed on the sliding surface, and
wherein the opposite side surface is configured to have surface roughness of a predetermined value.

9. The in-wheel motor of claim 8, further comprising a dust cover coupled to the stator and disposed on an outer side of the slinger.

10. The in-wheel motor of claim 1, wherein the rotor is disposed on a radially outer side of the stator.

11. The in-wheel motor of claim 1, wherein the rotor comprises a permanent magnet, and the stator comprises a coil, wherein a current is applicable to the coil.

12. A vehicle driven by the in-wheel motor of claim 1.

13. An in-wheel motor comprising:
a stator;
a rotor rotatably disposed relative to the stator; and
a seal connected to the stator and disposed to be in contact with a part of the rotor by at least one lip of the seal,
wherein the at least one lip is surface treated.

14. The in-wheel motor of claim 13, wherein the at least one lip is coated with a fluorine-based polymer, diamond-like carbon (DLC), or any combination thereof.

15. The in-wheel motor of claim 13, wherein the at least one lip comprises a pocket recessed from a surface of the at least one lip.

16. The in-wheel motor of claim 15, wherein the pocket is formed through sanding.

17. The in-wheel motor of claim 13, wherein the at least one lip comprises a plurality of lips, and some lips of the plurality of lips are surface treated.

18. The in-wheel motor of claim 13, wherein the rotor is disposed at a radially outer side of the stator.

19. The in-wheel motor of claim 13, wherein the rotor comprises a permanent magnet, and the stator comprises a coil configured to allow current to be applied thereto.

20. A vehicle driven by the in-wheel motor of claim 13.
